(19) United States
(12) Patent Application Publication
(10) Pub. No.: US 2017/0087795 A1
(43) Pub. Date: Mar. 30, 2017

(54) SHEET BUNDLE BINDING DEVICE AND IMAGE FORMING SYSTEM HAVING THE SAME

(71) Applicant: Mitsuhiro ISHIHARA, Yamanashi-ken (JP)

(72) Inventor: Mitsuhiro ISHIHARA, Yamanashi-ken (JP)

(73) Assignee: NISCA CORPORATION, Yamanashi-ken (JP)

(21) Appl. No.: 15/279,780

(22) Filed: Sep. 29, 2016

(30) Foreign Application Priority Data
Sep. 29, 2015 (JP) 2015-190833

(51) Int. Cl. B31F 5/02; B65H 43/00; G03G 15/00; B65H 37/04

(52) U.S. Cl. CPC B31F 5/02; B65H 37/04; B65H 43/00; G03G 15/6544; B65H 31/3081

(57) ABSTRACT

To provide a sheet bundle binding device capable of easily removing some sheets from a sheet bundle that has been subjected to staple-free binding. A corner Sc of a first sheet bundle Sb1 accumulated on a processing tray 24 is pressed and deformed between crimping toothed parts 54 and 55 of a staple-free binding unit 51 to bind the first sheet bundle Sb1 with a first binding force. Then, a corner of a second sheet bundle Sb2 obtained by accumulating additional sheets Sh2 on the first sheet bundle Sb1 is pressed and deformed between the crimping toothed parts 54 and 55 of the staple-free binding unit 51 to bind the second sheet bundle Sb2 with a second binding force smaller than the first binding force. Thus, the additional sheets can easily be removed from the second sheet bundle Sb2.

### BACKGROUND OF THE INVENTION

Field of the Invention

The present invention relates to a sheet bundle binding device that bundles a plurality of sheets fed from, e.g., an image forming device and automatically performs staple-free binding for the sheet bundle and an image forming system having the sheet bundle binding device.

Description of the Related Art

Recently, in addition to a stapling device that drives a metal needle into a plurality of stacked sheets to bind the sheets, there are used a staple-free binding device that sandwiches a plurality of stacked sheets between a pair of concavo-convex crimping teeth and strongly presses the sheets for pressure bonding to bind the sheets. Both the stapling device and staple-free binding device have a problem in that when some sheets need to be removed from the bound sheet bundle, the removing operation is very troublesome, and all the sheets of the sheet bundle tend to be separated from each other.

To solve the above problem, there is proposed an image forming device provided with a stapler that drives a staple needle in a sheet bundle stored in a discharge tray and a sewing unit that forms perforation on the sheet bundle at a position surrounding a stable needle driving position. With this configuration, a desired sheet can be cut off along the perforation to be removed from the sheet bundle (see, for example, Patent Document 1). Further, there is known a sheet post-processing device that unifies some small group sheet bundles bound by a staple needle driven inside a perforation into a large group sheet bundle and then binds the large group sheet bundle with a staple needle at a location outside of the perforation. With this configuration, the small group sheet bundle can be cut off along the perforation and removed from the large group sheet bundle (see, for example, Patent Document 2).

As an example of the staple-free binding device, there is known a sheet processing device that has a plurality of binding sections that perform staple-free binding for a sheet bundle at different binding positions, wherein a part of a sheet bundle bound at one binding position is bound together with another sheet bundle bound at another binding position so as to increase the number of sheets to be bound (see, for example, Patent Document 3). Further, as another example of the staple-free binding device, there is proposed a sheet biding device that changes an angle of a binding trace attached to a sheet bundle by a binding unit having a pair of crimping members having a concavo-convex shape arranged in a predetermined direction in order to change a binding force between sheets of the sheet bundle with respect to a sheet turning direction when press-bonding the sheet bundle (see, for example, Patent Document 4).

### Prior Art Document

### Patent Document

[Patent Document 1] Japanese Patent Application Publication No. 09-315669

[Patent Document 2] Japanese Patent Application Publication No. 2012-121711

[Patent Document 3] Japanese Patent Application Publication No. 2014-172693

[Patent Document 4] Japanese Patent Application Publication No. 2014-073681

The devices described in Patent Document 1 and Patent Document 2 need to be provided with a perforation forming unit for forming the perforation on the sheet, in addition to the stapler. This may enlarge the device size and complicate the device configuration and may require control for the device including the perforation forming unit. This not only opposes the miniaturization and speeding-up of the device, which are recently required, but also poses a problem of high price.

Further, as described in Patent Document 3, the sheet processing device having the plurality of binding sections has an enlarged and complicated configuration and thus needs to have a complicated control function for controlling operation of the enlarged and complicated configuration. Besides, in the first place, it is not easy to insert another binding section between the previously bound sheets.

The device described in Patent Document 4 can perform “proper binding” in which the binding force between the sheets with respect to the sheet turning direction is strong and “temporary binding” in which the binding force between the sheets with respect to the sheet turning direction is weak by a single binding unit. This can suppress cost increase and enlargement in device size more than in a case where a plurality of the binding units are separately provided. However, this document neither discloses nor suggests any method of removing some sheets from the bound sheet bundle.

### SUMMARY OF THE INVENTION

The present invention has been made in view of the above problems in the conventional technology, and an object thereof is to provide a sheet bundle binding device that performs staple-free binding or an image forming device having the sheet bundle binding device capable of easily removing some sheets from bound sheet bundle.

To solve the above-described problems of the conventional technologies, there is provided according to an aspect of the present invention, a sheet bundle binding device for staple-free binding of a plurality of sheets, including: a processing tray; a sheet accumulating mechanism that accumulates the plurality of sheets on the processing tray; and a binding unit that staple-free binds the plurality of sheets on the processing tray into a sheet bundle. The sheet accumulating mechanism accumulates additional sheets on a first sheet bundle that has been subjected to first binding processing by the binding device to form a second sheet bundle, and the binding unit performs second binding processing for the second sheet bundle.

As described above, in the binding device according to the present invention, the first binding processing and second binding processing are performed, and thus the binding processing can be easily performed in such a way that a plurality of sheets constituting one sheet bundle, i.e., the second sheet bundle are bound with different binding forces. More specifically, the binding force between the sheets constituting the first sheet bundle and that between the additional sheets are made different. In addition, the above binding processing can be achieved by a single device. That is, there is no need of using a separate or additional device or unit, thereby achieving a reduction in size, weight, and cost. Further, by changing the binding force, the number of times of binding processing, the position of the binding part, the area of the binding part between the first binding processing and the second binding processing, it is possible to change a sheet bundle binding mode according to an application of the sheet bundle.

The binding unit includes a pair of crimping toothed parts for binding the plurality of sheets into a sheet bundle, and a binding force between sheets of the first sheet bundle that has been subjected to the first binding processing is larger than a binding force between sheets of the second sheet bundle that has been subjected to the second binding processing. Thus, additional sheets added to the first sheet bundle can be easily removed from the second sheet bundle.

The sheet bundle binding device includes a binding position adjusting mechanism that moves the first sheet bundle to a first binding position where the first binding processing is performed and moves the first sheet bundle or the second sheet bundle to a second binding position where the second binding processing is performed. Thus, the binding force between the sheets of the first sheet bundle and that between the additional sheets can be made different.

The sheet bundle binding device may include a binding position adjusting mechanism that moves the binding unit to the first binding position where the first binding processing is performed and to the second binding position where the second binding processing is performed. By moving the binding unit to the binding positions, it is possible to prevent displacement between some sheets which can occur in a plurality of unbound sheets when they are subjected to movement after being accumulated and aligned, whereby the displacement between the sheets in the bound sheet bundle can be eliminated or reduced.

In the configuration where the binding position adjusting mechanism moves the sheet bundle, the binding position adjusting mechanism positions a first binding part and a second binding part which are formed respectively by the first binding processing and second binding processing so as to be in proximity to side edges of the respective first and second sheet bundles such that the second binding part is closer to the side edges of the respective first and second sheet bundles than the first binding part is. This can eliminate or reduce a drawback that the binding part of the second sheet bundle remaining on the first sheet bundle after removal of additional sheets from the second sheet bundle obstructs opening or page-turning operation of the first sheet bundle. Further, even when an image is formed on the opening side of a sheet surface of the first sheet bundle, adverse effect that the second binding part and the binding imprint thereof can have on the image can be eliminated or reduced.

The binding position adjusting mechanism sets the first and second binding parts to at least partially different positions such that an area of the first binding part formed by the first binding processing is larger than an area of the second binding part formed by the second binding processing. In general, when the same number of sheets are pressed and bound under the same pressure, a binding force between sheets of the sheet bundle is increased/decreased depending on the size of an area of the binding part. Thus, by setting the first and second binding parts as described above, the binding force between sheets of the first sheet bundle can easily be made larger than the binding force between the additional sheets in the second sheet bundle.

With the binding unit, even when a pressure of the press-binding to be applied to the first and second sheet bundles by the crimping tooth parts is the same between the first binding processing and the second binding processing, the binding force between sheets of the sheet bundle tends to be reduced with an increase in the number of sheets to be bound, so that the binding force between sheets of the first sheet bundle can easily be made larger than the binding force between the additional sheets in the second sheet bundle; alternatively, however, the binding unit may perform pressure control in such a way that a pressure of press-binding that the crimping tooth parts apply to the first sheet bundle in the first binding processing is larger than a pressure of press-binding that the crimping tooth parts apply to the second sheet bundle in the second binding processing.

In the configuration where the binding position adjusting mechanism moves the sheet bundle, the binding position adjusting mechanism includes: a sheet bundle moving unit that moves the first sheet bundle or the second sheet bundle; and a binding unit drive that moves the binding unit, wherein the sheet bundle moving unit moves the first sheet bundle to a plurality of different first binding positions, and the binding unit drive drives the binding unit so that it performs the first binding processing at the plurality of different first binding positions.

The binding position adjusting mechanism is a sheet bundle aligning mechanism for aligning the plurality of sheets accumulated on the processing tray into a sheet bundle.

Further, there is provided according to another aspect of the present invention, an image forming system including: an image forming unit that forms an image onto a sheet; and a sheet bundle binding unit that accumulates a plurality of sheets conveyed from the image forming unit and staple-free binds the plurality of sheets.

As described above, there can be provided a sheet bundle binding device capable of binding the first and second sheet bundles with different binding forces using a single binding device and, thus, capable of achieving a reduction in size, weight, and cost. Thus, an image forming system provided with a post-processing device capable of press-binding the sheet bundle while changing the binding force can be realized without enlarging the size of the entire system.

### BRIEF DESCRIPTION OF THE DRAWINGS

FIG. 1 is an explanatory view illustrating an entire configuration of an image forming system according to the present invention;

FIG. 2 is a side cross-sectional view of a post-processing unit of FIG. 1 as viewed from a device front side;

FIG. 3A and 3B are explanatory views each illustrating a sheet carry-in mechanism of the post-processing unit of FIG. 2;

FIG. 4 is an explanatory view illustrating a processing tray of the post-processing unit of FIG. 2 as viewed from above a sheet placing face;

FIG. 5A is an explanatory view illustrating a standby state of a sheet bundle carry-out mechanism, FIG. 5B is an explanatory view illustrating a sheet bundle conveying state, and FIG. 5C is an explanatory view illustrating a sheet bundle discharge state to a stack tray;

FIG. 6A is an explanatory view illustrating a configuration of a staple-free binding unit, FIG. 6B is a partially enlarged view illustrating a binding part of a sheet bundle that has been subjected to staple-free binding, and FIG. 6C is an enlarged cross-sectional view taken along a line B-B in FIG. 6B;

FIG. 7 is an explanatory view illustrating a control configuration of the image forming system of FIG. 1;

FIGS. 8A to 8C are explanatory views schematically illustrating a process of accumulating a sheet bundle carried in onto the processing tray and performing first binding as viewed from above the sheet placing face of the processing tray;

FIGS. 8D and 8E are explanatory views schematically illustrating a process of accumulating a sheet bundle carried in onto the processing tray and performing first binding as viewed from above the sheet placing face of the processing tray;

FIGS. 9A and 9B are explanatory views schematically illustrating a process of accumulating succeeding sheets on the sheet bundle that has been subjected to the first binding and performing second binding as viewed from above the sheet placing face of the processing tray;

FIGS. 9C and 9D are explanatory views schematically illustrating a process of accumulating succeeding sheets on the sheet bundle that has been subjected to the first binding and performing second binding as viewed from above the sheet placing face of the processing tray;

FIG. 10A is a partially enlarged plan view illustrating a binding part of a sheet bundle that has been subjected to the second binding, and FIG. 10B is a cross-sectional view taken along a line X-X in FIG. 10A; and

FIGS. 11A and 11B are explanatory views schematically illustrating a process of discharging the sheet bundle that has been subjected to the second binding to the stack tray as viewed from above the sheet placing face of the processing tray.

### DESCRIPTION OF THE PREFERRED EMBODIMENTS

Hereinafter, a preferred embodiment of the present invention will be described in detail with reference to the accompanying drawings. In the accompanying drawings, the same reference numerals are used to designate the same or similar components described throughout the specification.

In the present specification, “sheet bundle offset conveyance” refers to movement (widthwise shifting) of a sheet bundle obtained by accumulating sheets carried in onto a processing tray from a discharge port in a direction perpendicular to (crossing) a sheet conveying direction, and “offset amount” refers to a movement amount of the widthwise shifting. Further, “alignment of sheet bundle” refers to alignment of a plurality of sheets having different sizes carried in onto a processing tray from a discharge port with reference to a predetermined position (for example, “center reference” which is to align the sheets with reference to the center position of the processing tray in a direction perpendicular to the sheet conveying direction (i.e., width direction) or “side reference” which is to align the sheets with reference to one side of the processing tray in the width direction thereof). For example, “to perform offset after aligning the sheets” refers to aligning a plurality of sheets having different sizes with reference to the predetermined position and then moving the entire block of the aligned sheets to a direction perpendicular to the sheet conveying direction.

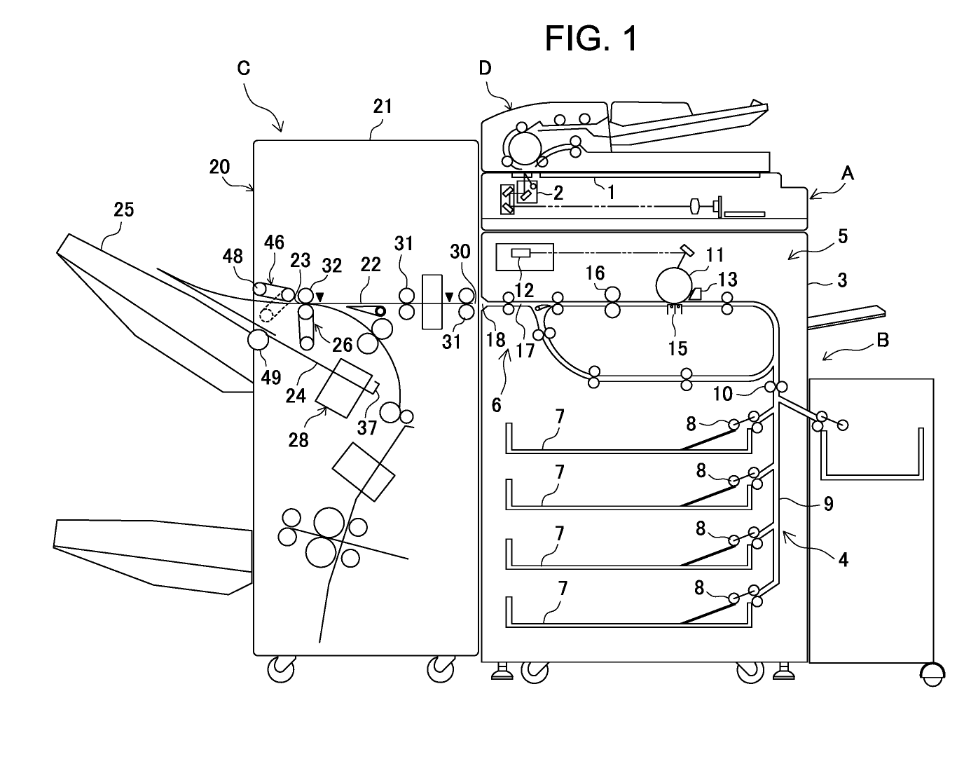

A sheet bundle binding device according to the present embodiment can perform staple-free binding for a sheet bundle obtained by aligning and accumulating a plurality of sheets on which an image is formed by an image forming system illustrated in FIG. 1 in two stages of proper binding and temporary binding. The proper binding refers to a binding state in which sheets of the bound sheet bundle are bound to each other with a strong binding force and cannot be easily peeled off (separated) from each other, and the temporary binding refers to a binding state in which sheets of the bound sheet bundle are bound to each other with a comparatively weak binding force and can be comparatively easily peeled off (separated) from each other.

The image forming system of FIG. 1 includes an image reading unit A, an image forming unit B, a post-processing unit C, and a document automatic feeding unit D. In the present specification, the near side of the image forming system in FIG. 1 is referred to as a device front side, and the far side thereof in FIG. 1 is referred to as a device rear side.

The image reading unit A includes a platen 1 formed of a transparent glass and a reading carriage 2 that is reciprocated along the platen 1 to read a document image. The document automatic feeding unit D feeds document sheets on a supply tray one by one to the platen 1, and the carriage 2 having a line sensor (photoelectric conversion element) arranged in a document width direction (main scan direction) is reciprocated in a sub scan direction perpendicular to the main scan direction to thereby read the document image in a line order.

The image forming unit B includes a supply section 4, an image forming section 5, and a discharge section 6 which are incorporated in a device housing 3 so as to form an image on a sheet based on image data of the document read by the image reading unit A. The supply section 4 supplies a sheet delivered by a supply roller 8 from a cassette 7 to the image forming section 5 through a supply path 9 according to an image forming timing of the image forming section 5. During the sheet supply operation, the leading end of the sheet is aligned by a resist roller pair 10. The image forming section 5 includes, e.g., an electrostatic image forming mechanism. The image forming section 5 forms a latent image (electrostatic latent image) on a photoconductor drum 11 constituted by a photoreceptor (photoconductor) using a light emitter 12, attaches toner ink to the latent image using a developing unit 13, transfers the toner image onto a sheet using a transfer charger 15, fixes the toner image on the sheet using a fixing unit (heating roller) 16, and feeds the resultant sheet to the discharge section 6. The discharge section 6 guides the image-formed sheet along a discharge path 17 and carries out the sheet to the post-processing unit C through a discharge port 18.

The post-processing unit C includes a sheet bundle binding device 20 according to the present embodiment and has a function of accumulating and aligning a plurality of sheets carried out from the image forming unit B to make them into a sheet bundle, binding the sheet bundle, and storing the sheet bundle in a downstream side stack tray. The post-processing unit C of the present embodiment has a stand-alone structure independent of the image reading unit A and image forming unit B, and the image reading unit A, image forming unit B, and post-processing unit C are connected by a network cable into one system. As another embodiment, the post-processing unit C may have an inner finisher structure. In this structure, the sheet bundle binding device 20 is incorporated, as a unit, in a sheet discharge space formed inside the device housing 3 of the image reading unit A.

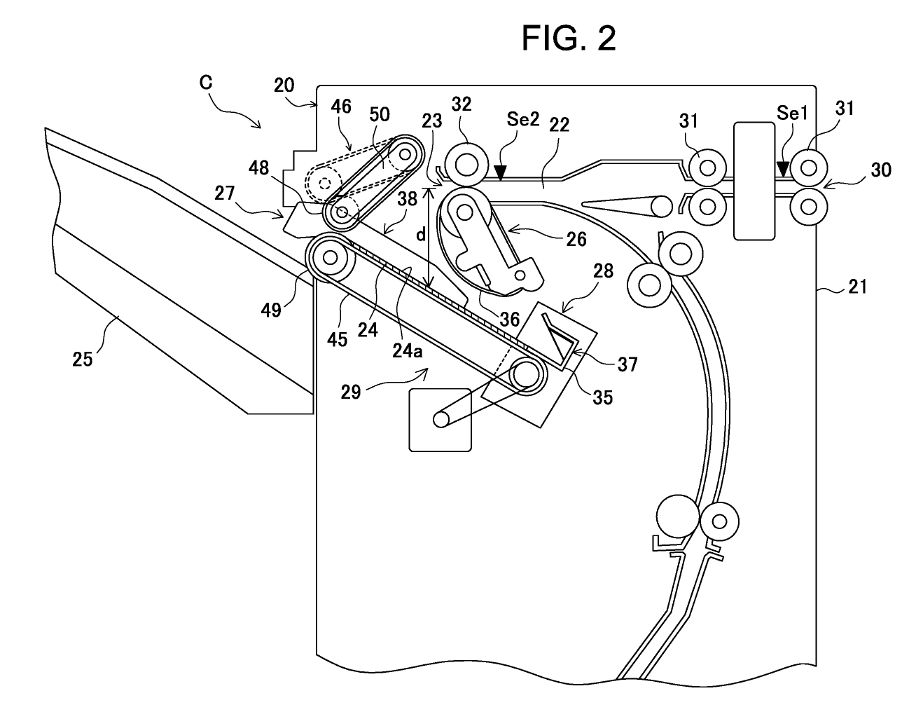

As illustrated in FIG. 2, the post-processing unit C includes a device housing 21, a discharge path 22 provided in the device housing 21, a processing tray 24 disposed downstream of a discharge port 23 of the discharge path 22, and a stack tray 25 disposed downstream of the processing tray 24. To execute the above-mentioned function of the post-processing unit C, there are provided in the processing tray 24 a sheet carry-in mechanism 26 for carrying a sheet discharged from the discharge port 23 to the back side of the processing tray 24, a sheet aligning mechanism 27 for accumulating a plurality of carried sheets in a bundled form and aligning them, a binding mechanism 28 for staple-free binding the aligned sheet bundle, and a sheet bundle carry-out mechanism 29 for carrying out the bound sheet bundle to the stack tray 25.

The discharge path 22 includes a feeder mechanism in which conveying roller pairs such as a carry-in roller pair 31, a discharge roller pair 32, and the like are arranged at predetermined intervals so as to convey a sheet fed from the image forming unit B from a carry-in port 30 to discharge port 23 in substantially the horizontal direction. Further, along the discharge path 22, sheet sensors Set and Se2 for detecting the leading end and/or rear end of a conveyed sheet are arranged.

As illustrated in FIG. 2, the processing tray 24 is disposed downstream of the discharge port 23 of the discharge path 22 with a level difference d below the discharge port 23. The processing tray 24 vertically stacks a plurality of sheets discharged from the discharge port 23 into a bundled form, i.e., a sheet bundle. To this end, the processing tray 24 includes a sheet placing face 24a for supporting at least a part of the sheet bundle. In the present embodiment, a structure (so-called a bridge support structure) that supports the front side of a sheet in the sheet carry-out direction by the stack tray 25 and supports the rear side thereof by the processing tray 24 is adopted. With this structure, the dimension of the entire tray is reduced in the carry-out (carry-in) direction.

The sheet carry-in mechanism 26 includes a conveying roller unit 46 so as to convey a sheet discharged from the discharge port 23 through the level difference d toward the back side of the processing tray 24 in a proper posture, (that is, with the left and right side edges of the sheet conveyed straight in the conveying direction) and smoothly. The conveying roller unit 46 includes a roller pair constituted of an upper conveying roller 48 and a lower driven roller 49 disposed with the processing tray 24 interposed therebetween. The conveying roller 48 is rotatably supported at the leading end of a bracket 50 swingably supported above the processing tray 24. The driven roller 49 is turnably provided at a fixed position immediately below the processing tray 24.

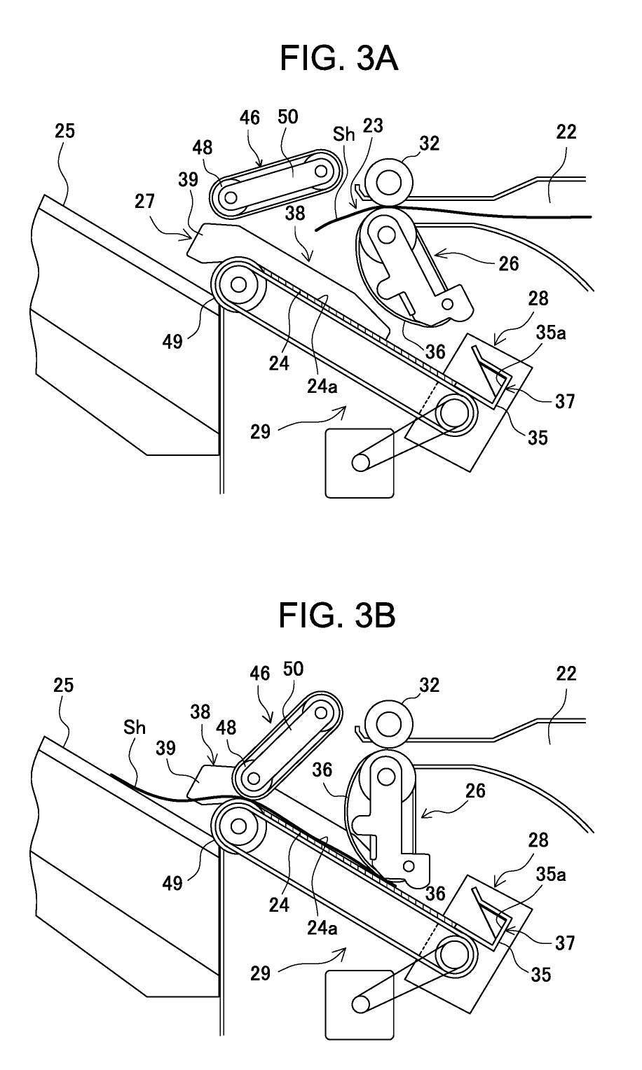

As illustrated in FIG. 3B, when the rear end of a sheet Sh discharged from the discharge port 23 reaches the processing tray 24, the bracket 50 is swung downward to cause the upper conveying roller 48 to abut against the upper surface of the sheet Sh on the processing tray 24. Then, the conveying roller 48 is, e.g., belt-driven by a drive motor (not illustrated) into rotation in the counterclockwise direction in the drawing. As a result, the sheet Sh is conveyed on the processing tray 24 until the leading end (right end in the drawing) thereof abuts against a regulation member 35 in an opposite direction to the carry-in direction (that is, to the side opposite to the stack tray 25). As illustrated in FIGS. 3A and 3B, the regulation member 35 is a channel-shaped member having a U-like cross section and has, inside thereof, a regulation face 35a for stopping the sheet Sh conveyed on the processing tray 24 by making the leading end of the sheet Sh in the carry-in direction abut thereagainst.

The sheet carry-in mechanism 26 further includes a raking rotor 36 for guiding a sheet leading end to the regulation member 35 so as to cope with sheet curling or skewing which can occur when a sheet is conveyed to the regulation member 35 on the processing tray 24. The raking rotor 36 is a ring-shaped or short cylindrical belt member disposed above the processing tray 24 in front of the regulation member 35 so as to be rotatable in the sheet carry-in direction. The belt member is engaged with the upper surface of a new sheet conveyed on the uppermost sheet of a sheet bundle stacked on the processing tray 24 and rotated in the counterclockwise direction in the drawing while pressing the leading end of the new sheet to convey the new sheet until it abuts the regulation face 35a of the regulation member 35.

The sheet aligning mechanism 27 is constituted of a sheet end regulation part 37 and a side aligning mechanism 38. The sheet end regulation part 37 includes the above-mentioned regulation member 35 to regulate the carry-in direction (or carry-out direction) position of a sheet carried in onto the processing tray 24 from the discharge port 23 at the leading of the sheet in the carry-in direction (or rear end of the sheet in the carry-out direction). The side aligning mechanism 38 moves a sheet and a sheet bundle on the processing tray 24 in a direction perpendicular to the carry-in (or carry-out) direction, i.e., in the width direction to regulate the width direction position of the sheet or sheet bundle at the side end edge thereof to thereby align the sheet or sheet bundle in the width direction.

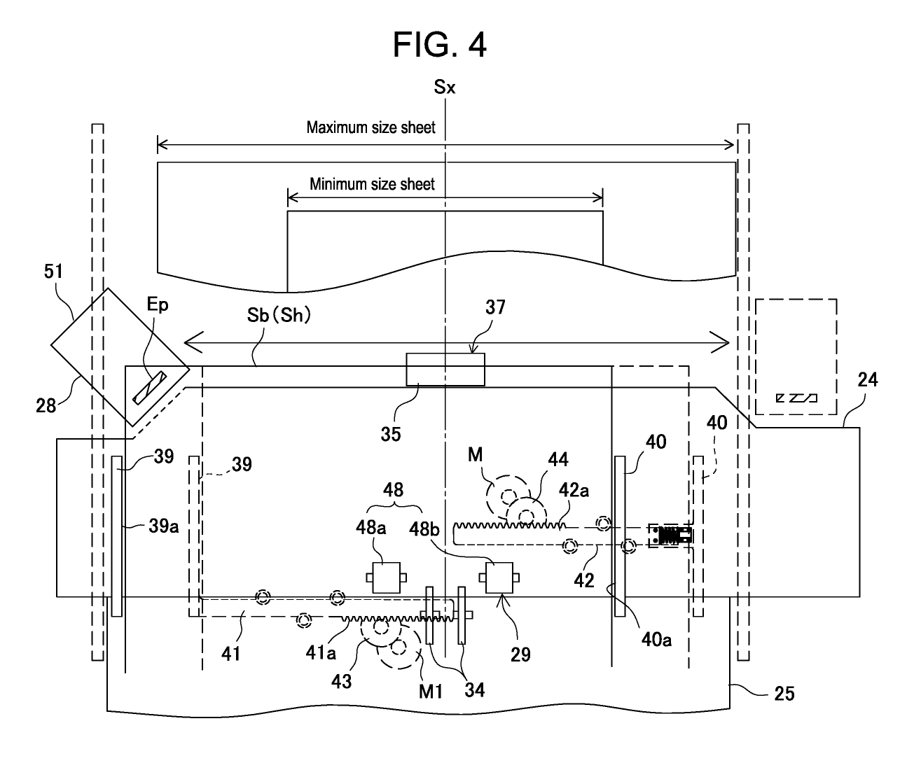

As illustrated in FIG. 4, the side aligning mechanism 38 has a pair of side aligning members 39 and 40 which are disposed left and right with a center reference line Sx interposed therebetween. The side aligning members 39 and are flat-plate like members extending perpendicularly upward from the sheet placing face 24a of the processing tray 24 with inner surfaces thereof facing each other. The inner surfaces of the respective side aligning members 39 and 40 function as regulation faces 39a and 40a which are engaged with adjacent width direction side end edges of the sheet Sh on the processing tray 24, respectively, to regulate the width direction position of the sheet Sh.

The side aligning members 39 and 40 are connected respectively integrally with movable support parts 41 and 42 disposed on the back surface side of the processing tray 24 through width direction linear slits (not illustrated) formed penetrating the processing tray 24. By individually turning pinions 43 and 44 meshing respectively with racks 41a and 42a formed in the respective support parts 41 and 42 by use of respective driving motors M1 and M2, the side aligning members 39 and 40 can be moved independently of each other in the direction approaching each other or separating from each other and stopped at desired width direction positions. Thus, it is possible to individually set the positions of the side aligning members 39 and 40 in accordance with the size of a sheet to be carried in the processing tray 24 and, when a sheet bundle is moved in the width direction (offset conveyance), the positions and offset amounts thereof can be determined.

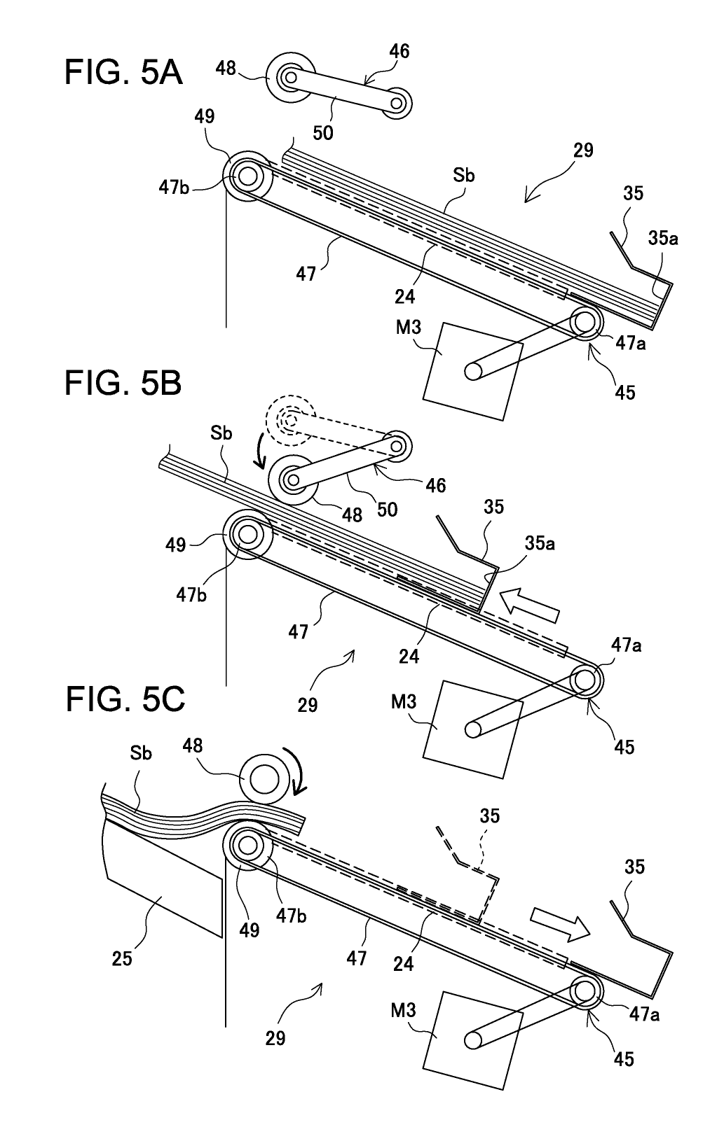

As illustrated in FIGS. 5A to 5C, the sheet bundle carry-out mechanism 29 is constituted of a conveyer unit 45 and the above-mentioned conveying roller unit 46. The conveyer unit 45 has a conveyer belt 47 wound between a driving pulley 47a driven by a drive motor M3 and a driven pulley 47b and revolved in both clockwise and counterclockwise directions along the sheet carry-out direction. The conveyer belt 47 is fixed with the regulation member 35 that also functions as a push-out member that is moved along the sheet placing face 24a of the processing tray 24 to push out a sheet bundle Sb in the carry-out direction. As illustrated in FIG. 5A, the regulation member 35 can be moved in both forward and backward directions between an initial position (FIG. 5A) near the rear end of the processing tray 24 in the carry-out direction and a maximum push-out position (denoted by a continuous line in FIG. 5B and by an imaginary line in FIG. 5C) which is substantially the intermediate position between the driving pulley 47a and the driven pulley 47b.

The conveying roller unit 46 has a configuration in which the conveying roller 48 and the driven roller 49 sandwich the sheet bundle Sb from above and below near the front end of the processing tray 24 in the carry-out direction so as to be capable of conveying the sheet bundle Sb. In the conveying roller unit 46, left and right two pairs of rollers (conveying roller 48 and driven roller 49) are arranged symmetrically with respect to the center reference line Sx.

When a bound sheet bundle Sb is carried out from the processing tray 24 to the stack tray 25, the regulation face 35a of the regulation member 35 is made to abut against the rear end of the sheet bundle Sb in the carry-out direction, as illustrated in FIG. 5A. Then, the conveyer unit 45 is driven to move the regulation member 35 in the carry-out direction up to the maximum push-out position, whereby the sheet bundle Sb is pushed out in the carry-out direction to be moved on the processing tray 24 to the position illustrated in FIG. 5B. At the same time, the bracket 50 of the conveying roller unit 46 is rotated in the counterclockwise direction in the drawing to bring the left and right conveying rollers 48a and 48b into pressure contact with the upper surface of the sheet bundle Sb.

Then, the conveying roller 48 is rotated by, e.g., a drive motor (not illustrated) in the clockwise direction in the drawing to convey the sheet bundle Sb in the carry-out direction to thereby carry out the sheet bundle Sb on the processing tray 24 to the stack tray 25, as illustrated in FIG. 5C. The regulation member 35 of the conveyer unit 45 holds the entire sheet bundle Sb inside thereof with the regulation face 35a abutting against the rear end of the sheet bundle Sb and can thus be driven at a comparatively high speed. On the other hand, the conveying roller 48 makes a direct contact with only the uppermost surface of the sheet bundle Sb, so that it is preferably rotated at a comparatively low speed to gradually feed the sheet bundle Sb toward the stack tray 25. Then, the regulation member is returned to the initial position by moving the conveyer belt 47 in the direction opposite to the carry-out direction.

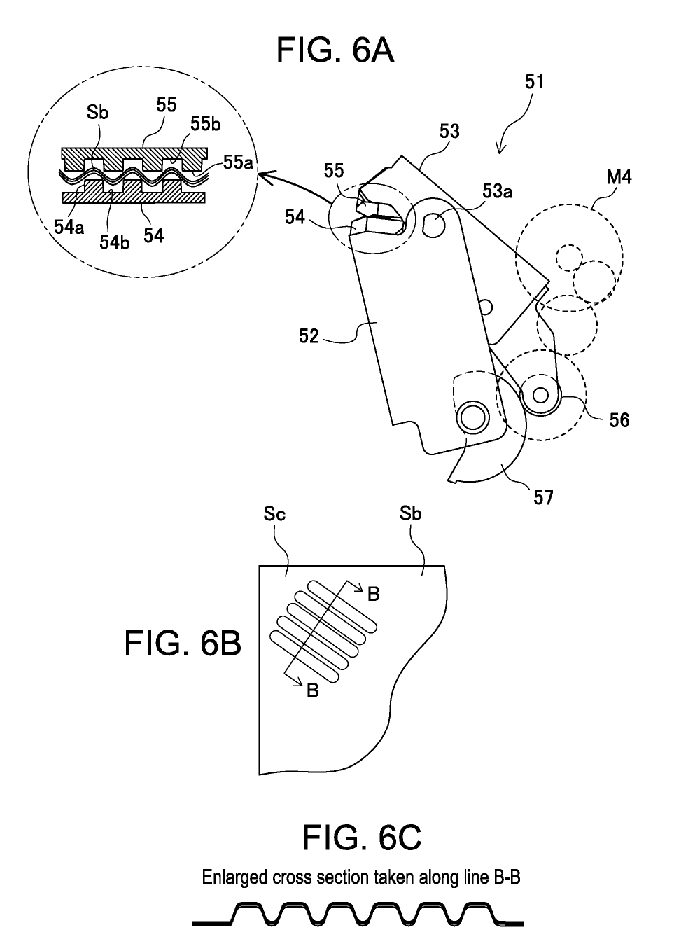

The binding mechanism 28 includes a staple-free binding unit 51 that staple-free binds a sheet bundle. The staple-free binding unit 51 according to the present embodiment is constituted of a crimping mechanism that presses a sheet bundle between crimping toothed parts each having a concave-convex surface into deformation to thereby bind the sheet bundle. As illustrated in FIG. 6A, the staple-free binding unit 51 has a configuration in which a movable frame member 53 is swingably supported to a base frame member 52 through a spindle 53a. The base frame member 52 has, at one end portion thereof, a lower crimping toothed part 54, and the movable frame member 53 has an upper crimping toothed part 55 at the position opposite to the lower crimping toothed part 54.

As illustrated in an enlarged manner in FIG. 6A, in the upper crimping toothed part 55, a plurality of rib-shaped protrusions 55a extending in the direction perpendicular to the teeth arrangement direction and a plurality of recessed grooves 55b each having a profile corresponding to the protrusion 55a are alternately formed. Similarly, in the lower crimping toothed part 54, a plurality of rib-shaped protrusions 54a extending in the direction perpendicular to the teeth arrangement direction and a plurality of recessed grooves 54b each having a profile corresponding to the protrusion 54a are alternately formed. The upper crimping toothed part 55 and the lower crimping toothed part 54 are disposed in such a way that the opposing projections and recessed grooves are engaged with each other.

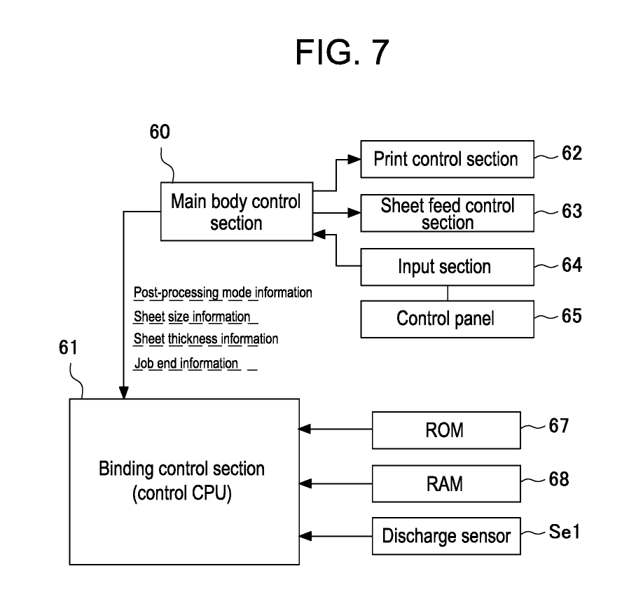

With this configuration, a corner Sc of a sheet bundle Sb held and pressed between the upper crimping toothed part 55 and the lower crimping toothed part 54 can be deformed into a wave-plate shape in cross section as illustrated in FIGS. 6B and 6C, whereby sheets constituting the sheet bundle Sb can firmly adhere to one another. In the present embodiment, as illustrated in FIG. 7B, the teeth arrangement direction of the upper crimping toothed part 55 and lower crimping toothed part 54 is disposed obliquely at a predetermined angle with respect to the center reference line Sx of the processing tray 24 so that the wave-plate shape of the binding part Sc is formed obliquely with respect to the sides of the sheet bundle Sb.

In the present embodiment, the protrusions 55a and 54a each have a linear ridge line extending perpendicular to the teeth arrangement direction. Alternatively, the ridge line of the projection may be inclined relative to the teeth arrangement direction. Further alternatively, the ridge line may be formed into various shapes other than the linear shape, such as a bent or curved shape. In such a case, the binding part Sc is formed into various wave-plate shapes corresponding to the shapes of the protrusions 55a and 54a.

The movable frame member 53 is provided integrally with a follower roller 56 at the end portion thereof on the opposite side to the upper crimping toothed part 55 with respect to the spindle 53a. The base frame member 52 is provided integrally with a drive cam 57 which is an eccentric cam at the end portion thereof on the opposite side to the lower crimping toothed part 54. The follower roller 56 is disposed in such a way that a follower surface thereof is engaged with a cam surface of the drive cam 57.

An unillustrated spring member is disposed between the base frame member 52 and the movable frame member 53. The spring member biases the upper crimping toothed part 55 and the lower crimping toothed part 54 in such a direction that they are separated from each other, that is, in such a direction that the follower surface of the follower roller and the cam surface of the drive cam 57 are always engaged with each other. Therefore, when the drive cam 57 is driven by a motor M4, the movable frame member 53 is swung about the spindle 53a following the cam surface. With this configuration, the upper crimping toothed part 55 and lower crimping toothed part 54 can be driven in such a way that they are engaged/brought into pressure contact with each other or separated from each other.

The presence of the spring member disposed between the base frame member 52 and the movable frame member 53 enables operation of separating the upper crimping toothed part 55 and lower crimping toothed part 54 from a state where the bound sheet bundle is held and pressed to be performed smoothly and quickly. Further, the base frame member 52 may be provided with an unillustrated position sensor so as to detect whether the upper crimping toothed part 55 and the lower crimping toothed part 54 are situated at the pressure-contact position or separated position. By receiving a signal representing a relative positional relationship between the upper crimping toothed part 55 and the lower crimping toothed part 54 from the position sensor, it is possible to perform peeling-off of the bound sheet bundle from the crimping toothed parts more smoothly and efficiently.

In the present embodiment, as illustrated in FIG. 4, a binding position Ep where a sheet bundle is staple-free bound is set at the back side of the processing tray 24 in the carry-in direction and immediately outside a corner 24b thereof on the device rear side, i.e., left side in the drawing so as not to overlap the processing tray 24. The staple-free binding unit 51 is disposed immediately outside the corner 24b of the processing tray 24 so as to correspond to the binding position Ep. Thus, the sheet bundle Sb carried in onto the processing tray 24 is staple-free bound at the back side in the carry-in direction with the device rear side corner as the binding position.

FIG. 7 schematically illustrates a control configuration of the image forming system of FIG. 1. The image forming system according to the present embodiment includes a main body control section 60 that controls the image forming unit B and a binding control section 61 that controls the post-processing unit C.

The main body control section 60 includes a print control section 62, a sheet feed control section 63, and an input section 65 connected to a control panel 64. The input section 65 can set an image forming mode and a post-processing mode through the control panel 64. In the image forming mode, printing modes such as color/monochrome printing and duplex printing/single-sided printing, and image forming conditions such as a sheet size, a sheet type, the number of print copies, and enlarged/reduced printing are set.

The post-processing mode includes a printout mode and a binding mode. The binding mode includes a normal mode in which only the proper binding is performed and a two-stage mode in which the proper binding and temporary binding are performed. When the printout mode is selected, a sheet discharged from the discharge port 23 is stored in the stack tray 25 through the processing tray 24 without being subjected to binding. In this case, sheets sequentially fed from the discharge port 23 can be stacked and accumulated on the processing tray 24 and then collectively carried out onto the stack tray 25 in response to a job end signal from the main body control section 60.

In the binding mode, a predetermined number of sheets discharged from the discharge port 23 are stacked and accumulated on the processing tray 24 into a bundle, then subjected to binding in the normal mode or two-stage mode, and carried out onto the stack tray 25. In the two-stage mode, the main body control section 60 transfers, to the binding control section 61, information indicating that the two-stage post-processing mode has been selected and, further, information such as the number of sheets constituting a sheet bundle to be subjected to first binding (proper binding), the number of sheets to be added for second binding (temporary binding) to the sheet bundle having been subjected to the first binding, the number of sheet bundles to be prepared, and the thickness of a sheet to be image-formed. Further, every time the image formation onto each sheet is ended, the main body control section 60 transfers the job end signal to the binding control section 61.

The binding control section 61 operates the post-processing unit C according to the setting of the post-processing mode input through the input section 65 of the main body control section 60. The binding control section 61 according to the present embodiment includes a control CPU as a control unit. The control CPU is connected with a ROM 67 and a RAM 68. A sheet bundle binding operation and a sheet bundle discharge operation by the post-processing unit C are executed based on a control program stored in the ROM 67 and control data stored in the RAM 68. Thus, the control CPU is connected to drive circuits of all the respective drive motors provided in the post-processing unit C so as to perform start/stop and normal/reverse rotation control for the drive motors.

When the two-stage binding mode is selected, the binding control section 61 moves the left-side aligning members 39 on the staple-free binding unit 51 side to a retreated position (denoted by a continuous line in FIG. 4) near the binding position Ep before carry-in of sheets onto the processing tray 24. Further, the binding control section 61 moves the right-side aligning member 40 to a retreated position sufficiently separated from the center reference line Sx to the device front side so as not obstruct movement of sheets to be carried in onto the processing tray 24.

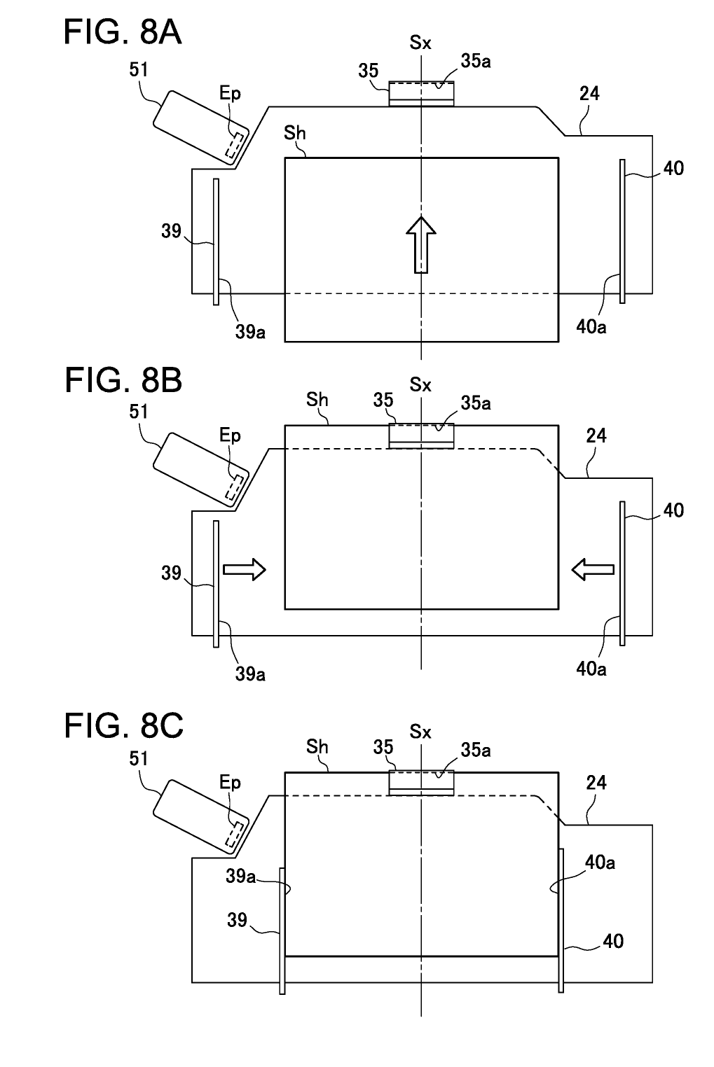

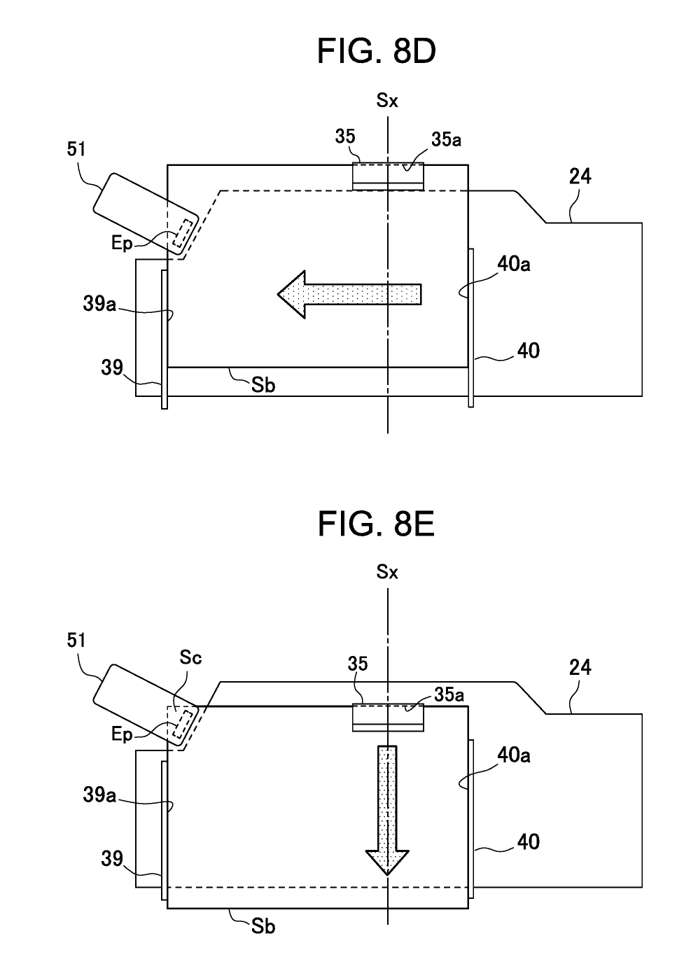

A process from the above standby state to when a sheet bundle is stored on the processing tray 24 and subjected to the first binding will be described using FIGS. 8A to 8E. As illustrated in FIG. 8A, when a sheet Sh1 is discharged onto the processing tray 24 from the discharge port 23 of the device housing 21, the binding control section 61 detects the discharge of the sheet Sh1 based on signals from the discharge sensors Se1 and Se2 and activates the sheet carry-in mechanism 26. Then, the sheet Sh1 on the processing tray 24 is conveyed in the direction opposite to the carry-out direction to the stack tray 25, that is, to the back of the processing tray 24. Then, as illustrated in FIG. 8B, the sheet Sh is conveyed by rotation of the raking rotor 36 until the leading end thereof in the carry-in direction abuts against the regulation face 35a of the regulation member 35.

After the conveyance of the sheet Sh is stopped by the regulation member 35, the binding control section 61 moves inward the left- and right-side aligning members 39 and 40 situated at their respective retreated positions (see FIG. 8A) so as to sandwich the sheet Sh1 from both sides. The side aligning members 39 and 40 are moved until the regulation faces 39a and 40a thereof are engaged with the both side end edges of the sheet Sh1, that is, until the interval therebetween coincides with the width of the sheet Sh1. As a result, as illustrated in FIG. 8C, a plurality of sheets Sh1 are accumulated as a first sheet bundle while being aligned with an accumulating position where the center of the sheets Sh1 coincides with the center reference line Sx of the processing tray 24. After that, the binding control section 61 returns the left- and right-side aligning members 39 and 40 to their respective retreated positions of FIG. 8A.

The above process illustrated in FIGS. 8A to 8C is repeated until a predetermined number of sheets constituting one sheet bundle to be subjected to the proper binding are accumulated on the processing tray 24 in the above-described aligned state. After the predetermined number of sheets Sh is aligned and accumulated on the processing tray 24, the binding control section 61 does not return the left- and right-side aligning members 39 and 40 to their respective retreated positions, but offset-moves the sheets Sh in the width direction toward the binding position Ep as a first sheet bundle Sb1 while holding the sheet bundle Sb1 with the aligning members 39 and 40 from both sides. The left- and right-side aligning members 39 and 40 are stopped so that the side end edge of the first sheet bundle Sb1 on the device rear side slightly exceeds the binding position Ep in the width direction.

At the position illustrated in FIG. 8D, the side end edge of the first sheet bundle Sb1 on the device rear side is disposed between the upper crimping toothed part 55 and lower crimping toothed part 54 of the staple-free binding unit 51 in a separated state so as to be sufficiently separate from the crimping toothed parts 55 and 54. In this state, the binding control section 61 drives the conveyer unit 45 of the sheet bundle carry-out mechanism 29 to move the regulation member 35 as the push-out member in the carry-out direction to push out the first sheet bundle Sb1 in the carry-out direction by a predetermined distance. The regulation member 35 stops the side end edge of the first sheet bundle Sb1 slightly before the binding position Ep in the carry-out direction. As a result, as illustrated in FIG. 8E, the first sheet bundle Sb1 is positioned at a first binding position where the corner Sc to be subjected to the proper binding completely includes the binding position Ep.

Then, the binding control section 61 issues a command signal that causes the staple-free binding unit 51 to execute first staple-free binding. In response to the command signal, as illustrated in FIG. 6B, the staple-free binding unit 51 presses and deforms the corner Sc of the first sheet bundle Sb1 into a wave-plate shape in cross section (see FIG. 6C) over the entire range of the mutually meshing upper crimping toothed part 55 and the lower crimping toothed part 54 to thereby bind the first sheet bundle Sb1. After the binding, the staple-free binding unit 51 separates the upper crimping toothed part 55 and lower crimping toothed part 54 from each other and issues a binding end signal to the binding control section 61.

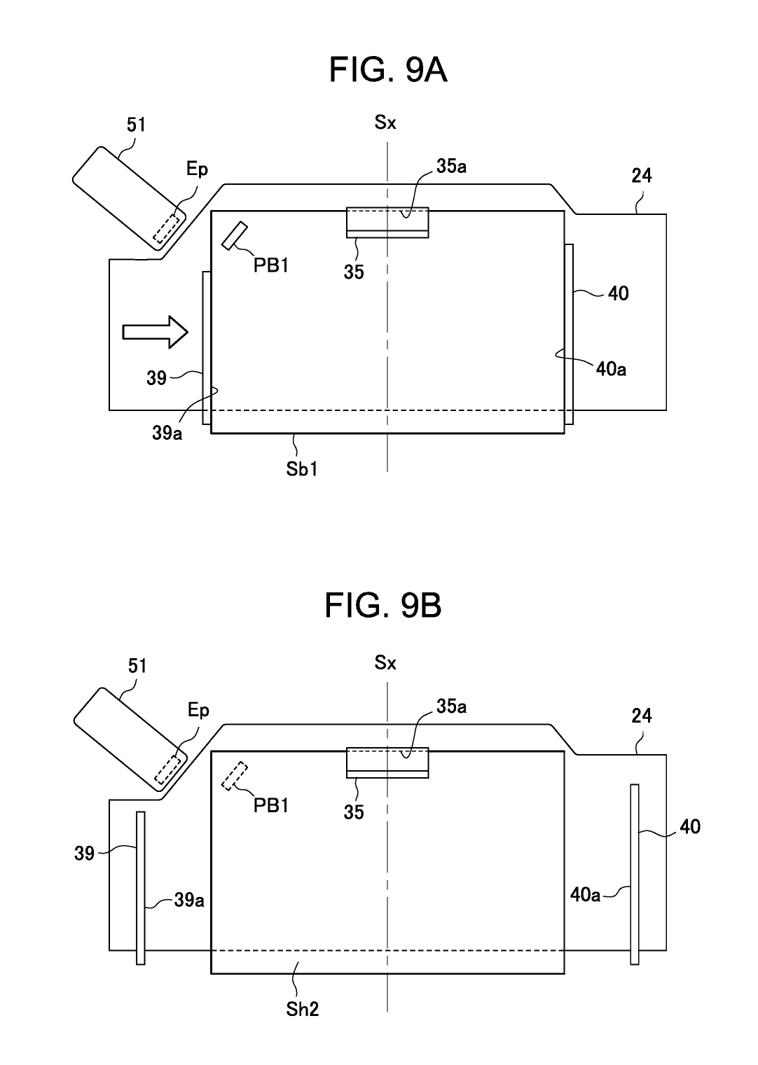

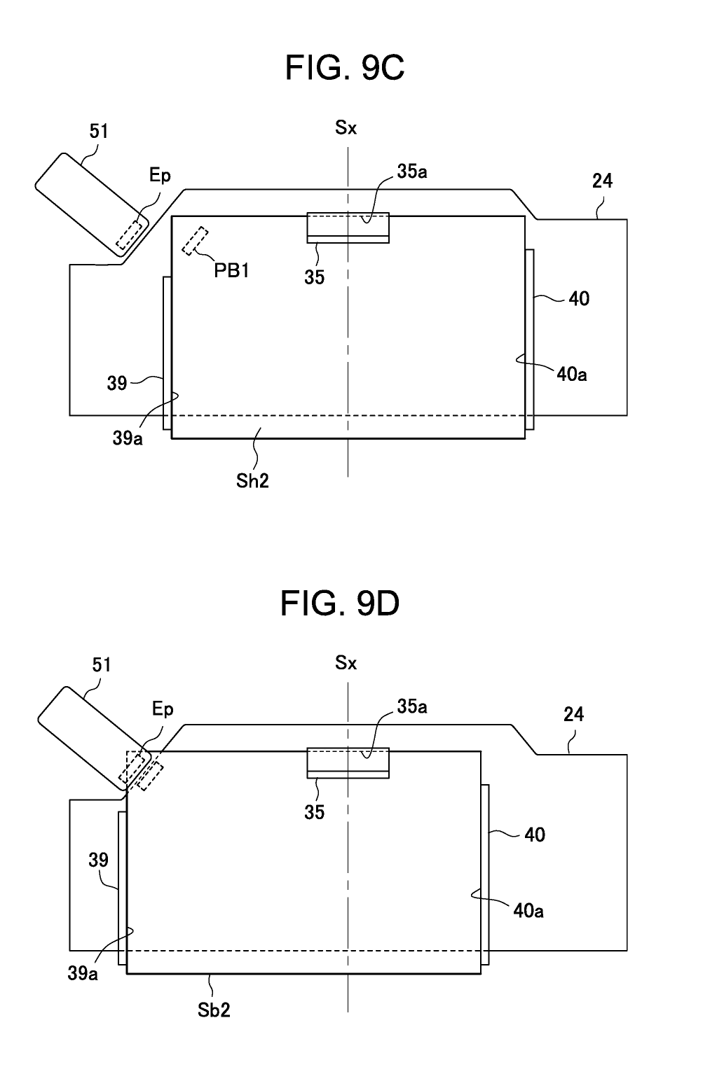

Upon reception of the binding end signal from the staple-free binding unit 51, the binding control section 61 performs the second binding for temporary binding of additional sheets in the first sheet bundle Sb1 that has been subjected to the proper binding. FIGS. 9A to 9D illustrate a process up to execution of the second binding for the first sheet bundle Sb1.

As illustrated in FIG. 9A, upon reception of the first binding end signal from the staple-free binding unit 51, the binding control section 61 moves the left- and right-side aligning members 39 and 40 to the side opposite to the binding position Ep in the width direction while holding the first sheet bundle Sb1 with the aligning members 39 and 40 from both sides to return the aligning members 39 and 40 to the accumulating position where the center of the first sheet bundle Sb1 in the width direction thereof coincides with the center reference line Sx. After that, the left- and right-side aligning members 39 and 40 are moved to their respective retreated positions illustrated in FIG. 8A. At this time, the regulation member 35 is maintained at the position illustrated in FIG. 8E where it has been moved for the first binding.

Then, the binding control section 61 detects an additional sheet Sh2 discharged onto the processing tray 24 from the discharge port 23 of the device housing 21 based on signals from the discharge sensors Se1 and Se2 and then activates the sheet carry-in mechanism 26 to feed the sheet Sh2 on the first sheet bundle Sb1 to the back of the processing tray 24. As illustrated in FIG. 9B, the additional sheet Sh2 is conveyed by rotation of the raking rotor 36 until the leading end thereof in the carry-in direction abuts against the regulation face 35a of the regulation member 35.

After the conveyance of the additional sheet Sh2 is stopped by the regulation member 35, the binding control section 61 moves inward the left- and right-side aligning members 39 and 40 situated at the their respective retreated positions (see FIG. 9B) so as to sandwich the additional sheet Sh2 from both sides. The side aligning members 39 and 40 are moved until the regulation faces 39a and 40a thereof are engaged with the both side end edges of the additional sheet Sh2, that is, until the interval therebetween coincides with the width of the additional sheet Sh2. As a result, a plurality of additional sheets Sh2 are stacked on the first sheet bundle Sb1, and the resultant sheet bundle (second sheet bundle Sb2) is positioned while being aligned with the accumulating position where the center of the second sheet bundle Sb2 coincides with the center reference line Sx of the processing tray 24, as illustrated in FIG. 9C. After that, the binding control section 61 returns the left- and right-side aligning members 39 and 40 to their respective retreated positions of FIG. 9B.

The above process illustrated in FIGS. 9A to 9C is repeated until a predetermined number of additional sheets Sh2 is accumulated on the processing tray 24 in the above-described aligned state. After the predetermined number of additional sheets Sh2 is aligned and accumulated on the first sheet bundle Sb1 stacked on the processing tray 24, the binding control section 61 does not return the left- and right-side aligning members 39 and 40 to their retreated positions, but offset-moves the second sheet bundle Sb2 in the width direction toward the binding position Ep while holding the second sheet bundle Sb2 with the aligning members 39 and 40 from both sides.

The left- and right-side aligning members 39 and 40 are stopped so that the side end edge of the second sheet bundle Sb2 on the device rear side is slightly inward from the stop position (FIG. 8E) in the first binding. More specifically, the second sheet bundle Sb2 is disposed at a second binding position where the range of the mutually meshing crimping teeth parts of the staple-free binding unit 51, i.e., a part of the binding position Ep is displaced outward from the corner Sc of the second sheet bundle Sb2.

At the second binding position, the binding control section 61 issues a command signal that causes the staple-free binding unit 51 to execute second staple-free binding. In response to the command signal, the staple-free binding unit 51 presses and deforms the corner Sc of the second sheet bundle Sb2 into the wave-plate shape in cross section in a partial range of the mutually meshing upper crimping toothed part 55 and lower crimping toothed part 54 to thereby bind the second sheet bundle Sb2.

As described above, in the present embodiment, the regulation member 35 of the sheet bundle carry-out mechanism 29 and the aligning members 39 and 40 of the sheet aligning mechanism 27 are used to move the sheet bundle from the first binding position to the second binding position for adjustment of the binding part of the sheet bundle. Alternatively, however, a separate binding position adjusting mechanism may be provided for movement of the sheet bundle from the first binding position to the second binding position.

Further, in the present embodiment, the first sheet bundle that has been subjected to the first binding is once returned from the first binding position to the accumulating position, and then the additional sheets are stacked on the first sheet bundle to constitute the second sheet bundle, and the second sheet bundle is moved to the second binding position. Alternatively, however, the process of returning the first sheet bundle to the accumulating position may be omitted. For example, while the first sheet bundle that has been subjected to the first binding is held at the first binding position, the additional sheets may be stacked on the first sheet bundle. With this configuration, the second sheet bundle can be moved directly from the first binding position to the second binding position. Further, the first sheet bundle that has been subjected to the first binding may be moved directly from the first binding position to the second binding position, followed by stacking of the additional sheets on the first sheet bundle at that position to form the second sheet bundle.

Further, alternatively, not the sheet bundle, but the staple-free binding unit 51 may be moved for adjustment of the binding position on the sheet bundle. For example, during a process of returning the first sheet bundle that has been subjected to the first binding from the first binding position to the accumulating position and stacking the additional sheets on the first sheet bundle, the staple-free binding unit 51 is moved from a first position for the first binding to a second position for the second binding. Then, the second sheet bundle obtained by stacking the additional sheets on the first sheet bundle is moved from the accumulating position to the same binding position where the first binding has been performed, and the staple-free binding unit 51 is driven to perform the second binding.

In the above embodiment, the stacking of the additional sheets may be performed without moving the first sheet bundle to the accumulating position. For example, after the first binding, the staple-free binding unit 51 is once retreated from the first position for the first binding. The first sheet bundle is not moved, but the additional sheets are stacked directly thereon. Then, the staple-free binding unit 51 is moved to the second position for the second binding, followed by execution of the second binding. As described above, by making the staple-free binding unit 51 movable, the staple-free binding can be performed for the sheet bundle at various positions along the side edges thereof. Thus, it is possible to realize various binding modes according to application or usage of the bound sheet bundle.

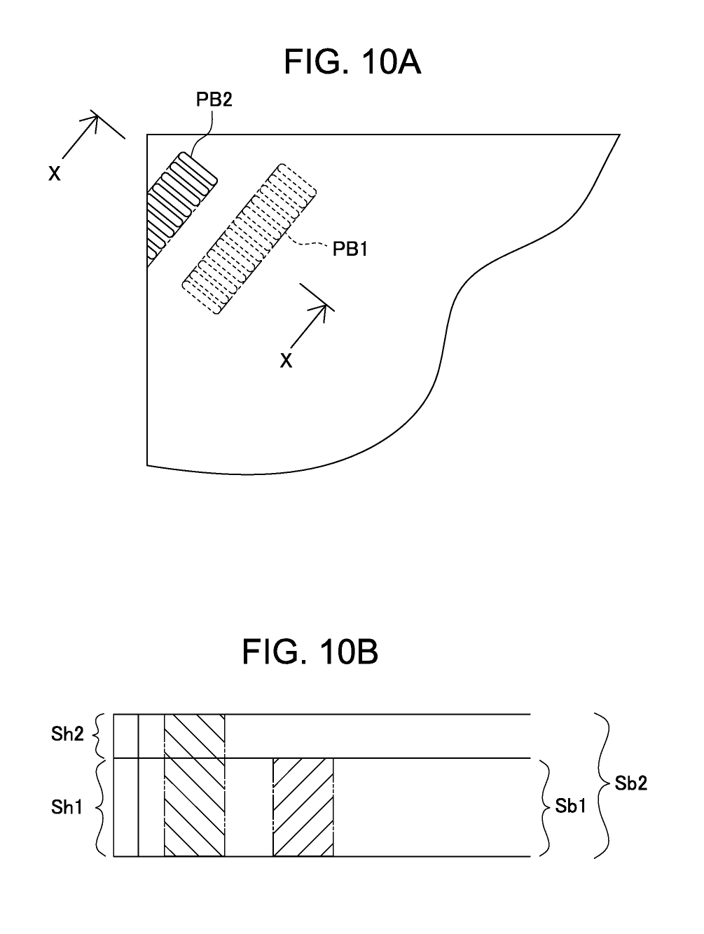

FIGS. 10A and 10B illustrate, in a partially enlarged manner, binding states of a first binding part PB1 of the first sheet bundle Sb1 that has been subjected to the proper binding through the first binding and a second binding part PB2 of the second sheet bundle b2 obtained by applying the temporary binding to the additional sheets Sh2 through the second binding. As described above, at the first binding part PB1, the sheets are pressed and bound over the entire range of the upper crimping toothed part 55 and lower crimping toothed part 54, so that a predetermined binding force specified in the staple-free binding unit 51 is exhibited.

In general, when a certain number of sheets are pressed and bound with the same pressure, a binding force for binding the sheet bundle is increased/decreased depending on the size of an area of the binding part and the number of bound sheets. As described above, at the second binding part PB2, the sheets are pressed and bound in a partial range of the upper crimping toothed part 55 and lower crimping toothed part 54, and the number of the second sheet bundle Sb2 is larger than the first sheet bundle Sb1 by the number of the additional sheets Sh2. Further, the second binding part PB2 is formed in such a way that the upper crimping toothed part 55 and lower crimping toothed part 54 cross the side edge of the second sheet bundle Sb2. Thus, the binding force at the second binding part PB2 is smaller than at the first binding part PB even when the press-binding is performed with the same pressure as in the first binding, so that the additional sheets Sh2 can be removed from the second sheet bundle Sb2 more easily than the sheets Sh1 of the first sheet bundle Sb1.

Further, it is known that it is easier to peel off the sheet in an arrangement direction of the waves of the wave-plate shape than to peel off the sheet in a direction along the ridge line of the waves. Thus, by forming the binding part in such a way that the wave ridge line direction substantially coincides with an acting direction of the sheet peeling-off operation, the sheet is not peeled off easily. Conversely, by forming the binding part in such a way that the wave ridge line direction crosses (especially, crosses at right angles) the acting direction of the sheet peeling-off operation, the sheet can be peeled off from the sheet bundle comparatively easily.

When the binding parts are formed at the upper-left corner Sc of the sheet bundles Sb and Sb2 as illustrated in FIG. 6B and 10A, an operation of turning pages of the sheet bundle may often be conducted diagonally from the lower-right corner to the upper-left corner. Therefore, when the binding parts are formed at the corner of the sheet bundle in the manner as illustrated in FIG. 6B and 10A, the sheet is not peeled off easily by a normal page-turning operation. In this case, by intentionally peeling off the sheet in a direction crossing the normal page-turning operation, the sheet can be removed from the sheet bundle easily.

The same is applied to a case where the binding part is formed along the side edge of the sheet bundle. For example, when the binding parts are formed along the left long sides of the respective sheet bundles Sb and Sb2, the page-turning operation may be conducted from the right to the left in general. Therefore, when the biding part is formed in such a way that the wave arrangement direction substantially coincides with the long side direction of the sheet bundle, the sheet is not peeled off easily by a normal page-turning operation; on the other hand, by intentionally peeling off the sheet in a direction crossing the normal page-turning operation, the sheet can be removed from the sheet bundle easily.

Further, it is found that when an end portion of the binding part in the wave arrangement direction contacts the side edge of the sheet bundle, the sheet is not peeled off easily even when the page turning operation is conducted along the wave arrangement direction. Thus, the binding part is formed in such a way that the end portion thereof in the wave arrangement direction contacts the edge of the side from which the pages of the sheet bundle are often turned so that the sheet is not peeled off easily by a normal page-turning operation; on the other hand, by intentionally peeling off the sheet in a direction opposite to or crossing the normal page-turning operation, the sheet can be removed from the sheet bundle easily.

For example, in the example of FIG. 10A, the second binding part PB2 is formed in such a way that the end portion thereof in the wave arrangement direction contacts the side edge of the second sheet bundle Sb2. Thus, the additional sheet Sh2 is not peeled off easily by a normal page-turning operation conducted from the lower short side toward the upper short side, but can be removed from the second sheet bundle Sb2 easily by intentionally peeling the additional sheet Sh2 in a direction opposite to or crossing the normal page-turning operation.

Further, when a binding imprint of the second binding part PB2 remains on an opened sheet surface of the first sheet bundle Sb1 after removal of the additional sheets Sh2 from the second sheet bundle Sb2, not only appearance degradation of the sheet bundle, but also any adverse effect, such as deterioration in quality of an image formed on that surface, may occur. Further, when the second binding part PB2 is present at the opening side of the sheet, the binding force by the second binding part PB2 may obstruct smooth page-turning or opening operation of the first sheet bundle Sb1.

Thus, the second binding part PB2 preferably comes closer to the side of the second sheet bundle Sb2 in proximity to the first binding part PB1 than the first binding part PB1 comes. Thus, after removal of the additional sheets Sh2 from the second sheet bundle Sb2, the first sheet bundle Sb1 can smoothly be opened or turned without being obstructed by the second binding part PB2 and the binding imprint thereof. Further, adverse effect that the second binding part PB2 and the binding imprint thereof can have on the image formed on the opened sheet surface of the first sheet bundle Sb1 can be eliminated or reduced.

In the above embodiment, in order to move the second sheet bundle Sb2 from the accumulating position to the second binding position, the left- and right-side aligning members 39 and 40 are used to move the second sheet bundle Sb2 only in the width direction. Alternatively, in addition to or in place of the left- and right-side aligning members 39 and 40, that is, in addition to or in place of the width direction, the regulation member 35 may used to move the second sheet bundle Sb2 in the sheet conveying direction toward the second binding position.

For example, the left- and right-side aligning members 39 and 40 are used to return the second sheet bundle Sb2 in the width direction from the accumulating position to the same position as the first binding position, and then the regulation member 35 is used to move the second sheet bundle Sb2 in the sheet carry-out direction. This allows the second binding part to be provided at the width-direction side perpendicular to the side at which the second binding part PB2 (FIG. 10A) of the second sheet bundle Sb2 is provided. Further, by appropriating the left- and right-side aligning members 39 and 40 and/or the regulation member 35, it is possible to locate and adjust the second binding part at various positions with respect to the first binding position.

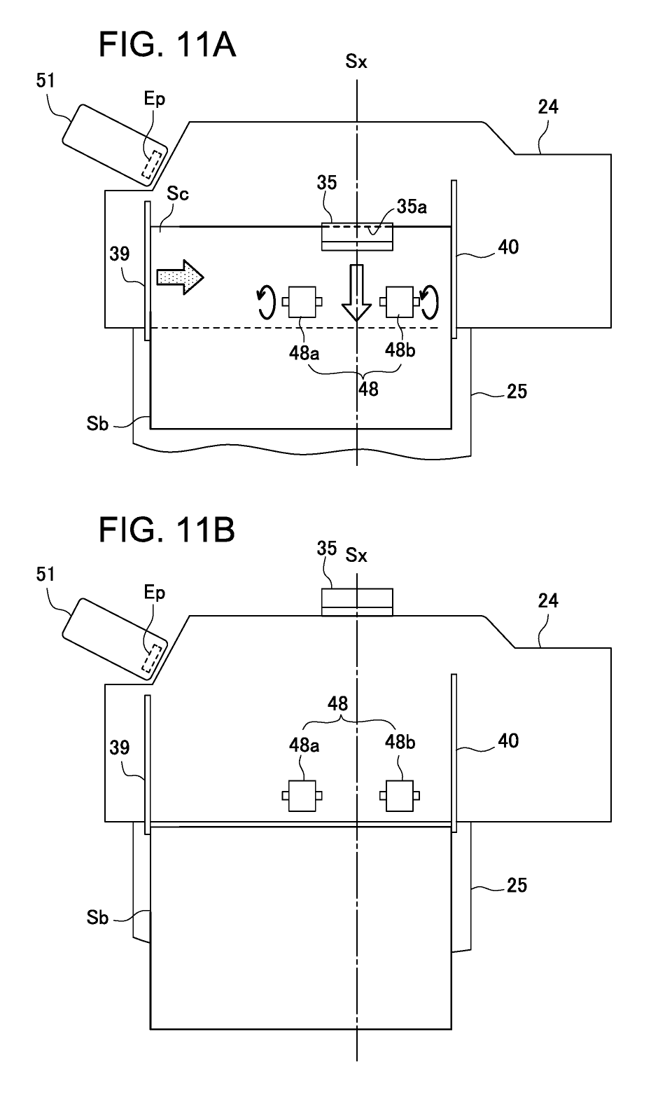

After the second binding illustrated in FIG. 9B, the staple-free binding unit 51 separates the upper crimping toothed part 55 and the lower crimping toothed part 54 from each other and issues a binding end signal to the binding control section 61. The binding control section 61 drives the conveyer unit 45 to move the regulation member 35 in the carry-out direction. The regulation member 35 is moved up to the maximum push-out position illustrated in FIG. 5B while pushing out the second sheet bundle Sb2, as illustrated in FIG. 11A and stopped there. At the same time, the binding control section 61 lowers the two brackets 50 of the conveying roller unit 46 to bring the left and right conveying rollers 48 into pressure contact with the upper surface of the second sheet bundle Sb2.

Further, the binding control section 61 rotates the two conveying rollers 48 to convey the second sheet bundle Sb2 in the carry-out direction from the processing tray 24 to the stack tray 25, as illustrated in FIG. 11B. At this time, in order to prevent the uppermost sheet of the second sheet bundle Sb2 from slipping on the lower side sheet, the conveying rollers 48 are preferably rotated at a comparatively low speed to gradually feed the sheet bundle Sb to the stack tray 25.

At this time, as illustrated in FIGS. 11A and 11B, the regulation member 35 and two conveying rollers 48 of the present embodiment are significantly displaced from the center of the second sheet bundle Sb2 in the width direction. However, the left and right both end edges of the second sheet bundle Sb2 are regulated by the left- and right-side aligning members 39 and 40, so that the second sheet bundle Sb2 keeps a straight posture with respect to the carry-out direction while it is carried out by the regulation member 35 and two conveying rollers 48.

In the above embodiment, by changing the area of the binding part that the staple-free binding unit 51 forms on the sheet bundle, the binding force between the sheets of the sheet bundle is changed and adjusted. Alternatively, by changing a pressure to be applied to the upper crimping toothed part 55 and lower crimping toothed part 54 of the staple-free binding unit 51, the binding force between the sheets of the sheet bundle can be increased/decreased, whereby the additional sheets bound by the second binding can be removed easily.

Further, it is possible to perform the first binding many times for the first sheet bundle Sb1 while changing the binding position. In this case, even when the pressure to be applied to the crimping toothed parts of the staple-free binding unit in the first binding is equal to or smaller than that applied in the second binding, by making the total area of the binding parts of the first sheet bundle Sb1 larger than the area of the binding part of the second sheet bundle Sb2, the binding force between the sheets of the first sheet bundle Sb1 can be made larger than that between the sheets of the second sheet bundle Sb2. Further, even when the second binding is performed many times, the same effect can be obtained by making the number of times of execution of the first binding larger than that of the second binding.

Further, the areas of the binding parts of the first and second sheet bundles can be changed not by moving the sheet bundles with the staple-free binding unit 51 fixed but by moving the staple-free binding unit 51 with the sheet bundles fixed. At this time, the staple-free binding unit 51 can be moved in such a way that the teeth arrangement direction is made different between the first binding and second binding so as to make the first and second binding parts cross each other. This can further reduce the size, especially, the planar size of the binding part of the second sheet bundle.

While the present invention has been described in connection with preferred embodiments, it is not limited thereto. It will be apparent that various modifications and changes can be made thereto within the technical scope of the invention. For example, the sheet bundle binding position and the position of the staple-free binding unit with respect to the processing tray can be set at various positions different from those of the embodiment.

1. A sheet bundle binding device for staple-free binding of a plurality of sheets, comprising:
a processing tray;
a sheet accumulating mechanism that accumulates the plurality of sheets on the processing tray; and
a binding unit that staple-free binds the plurality of sheets on the processing tray into a sheet bundle,
the sheet accumulating mechanism accumulating additional sheets on a first sheet bundle that has been subjected to first binding processing by the binding device to form a second sheet bundle,
the binding unit performing second binding processing for the second sheet bundle.

2. The sheet bundle binding device according to claim 1, wherein
the binding unit includes a pair of crimping toothed parts for binding the plurality of sheets into a sheet bundle, and
a binding force between sheets of the first sheet bundle that has been subjected to the first binding processing is larger than a binding force between sheets of the second sheet bundle that has been subjected to the second binding processing.

3. The sheet bundle binding device according to claim 1, further comprising a binding position adjusting mechanism that moves the first sheet bundle to a first binding position where the first binding processing is performed and moves the first sheet bundle or second sheet bundle to a second binding position where the second binding processing is performed.

4. The sheet bundle binding device according to claim 1, further comprising a binding position adjusting mechanism that moves the binding unit to a first binding position where the first binding processing is performed and to a second binding position where the second binding processing is performed.

5. The sheet bundle binding device according to claim 3, wherein
the binding position adjusting mechanism positions a first binding part and a second binding part which are formed respectively by the first binding processing and second binding processing so as to be in proximity to side edges of the respective first and second sheet bundles in such a way that the second binding part is closer to the side edges of the respective first and second sheet bundles than the first binding part is.

6. The sheet bundle binding device according to claim 4, wherein
the binding position adjusting mechanism positions a first binding part and a second binding part which are formed respectively by the first binding processing and second binding processing so as to be in proximity to side edges of the respective first and second sheet bundles in such a way that the second binding part is closer to the side edges of the respective first and second sheet bundles than the first binding part is.

7. The sheet bundle binding device according to claim 3, wherein
the binding position adjusting mechanism sets the first and second binding parts to at least partially different positions such that an area of the first binding part formed by the first binding processing is larger than an area of the second binding part formed by the second binding processing.

8. The sheet bundle binding device according to claim 4, wherein
the binding position adjusting mechanism sets the first and second binding parts to at least partially different positions such that an area of the first binding part formed by the first binding processing is larger than an area of the second binding part formed by the second binding processing.

9. The sheet bundle binding device according to claim 3, wherein
the binding position adjusting mechanism sets the second binding part to a position partially crossing a side edge of the second sheet bundle in such a way that an area of the first binding part formed by the first binding processing is larger than an area of the second binding part formed by the second binding processing.

10. The sheet bundle binding device according to claim 4, wherein
the binding position adjusting mechanism sets the second binding part to a position partially crossing a side edge of the second sheet bundle in such a way that an area of the first binding part formed by the first binding processing is larger than an area of the second binding part formed by the second binding processing.

11. The sheet bundle binding device according to claim 2, wherein
the binding unit performs pressure control in such a way that a pressure of press-binding that the crimping tooth parts apply to the first sheet bundle in the first binding processing is larger than a pressure of press-binding that the crimping tooth parts apply to the second sheet bundle in the second binding processing.

12. The sheet bundle binding device according to claim 3, wherein
the binding position adjusting mechanism includes:
a sheet bundle moving unit that moves the first sheet bundle or second sheet bundle; and
a binding unit drive that moves the binding unit, wherein
the sheet bundle moving unit moves the first sheet bundle to a plurality of different first binding positions, and
the binding unit drive drives the binding unit so that it performs the first binding processing at the plurality of different first binding positions.

13. The sheet bundle binding device according to claim 4, wherein
the binding position adjusting mechanism includes:
a sheet bundle moving unit that moves the first sheet bundle or second sheet bundle; and
a binding unit drive that moves the binding unit, wherein
the sheet bundle moving unit moves the first sheet bundle to a plurality of different first binding positions, and
the binding unit drive drives the binding unit so that it performs the first binding processing at the plurality of different first binding positions.

14. The sheet bundle binding device according to claim 3, wherein
the binding position adjusting mechanism is a sheet bundle aligning mechanism for aligning the plurality of sheets accumulated on the processing tray into a sheet bundle.

15. An image forming system provided with the sheet bundle binding device as claimed in claim 1, comprising:
an image forming unit that forms an image onto a sheet; and
a sheet bundle binding unit that accumulates a plurality of sheets conveyed from the image forming unit and staple-free binds the plurality of sheets.
